(19) United States
(12) Patent Application Publication
(10) Pub. No.: US 2007/0080601 A1
(43) Pub. Date: Apr. 12, 2007

(54) Commutator

(76) Inventors: Gerald Kuenzel, Lichtenau (DE); Christof Bernauer, Hundsbach (DE); Christian Bauer, Lauf (DE); Marcus Schulz, Buehlertal (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/579,570

(22) PCT Filed: Sep. 24, 2004
(86) PCT No.: PCT/DE04/02139

§ 371 Date: May 17, 2006

(30) Foreign Application Priority Data
Nov. 28, 2003 (DE) 103 55 805.5

(51) Int. Cl. H01R 39/04; H02K 13/04

(52) U.S. Cl. 310/233; 310/236

(57) ABSTRACT

A commutator for an electrical machine, which has a plurality of laminations that have contact faces and are separated from one another by slots in which, in the laminations, at least one groove is provided in the contact face, which groove extends essentially in the longitudinal direction of the respective lamination. As a result, the frequency with which the brushes are excited by the commutator can be increased, which has a favorable effect on noise.

### PRIOR ART

The invention is based on a commutator for an electrical machine as generically defined by the preamble to claim 1. Such a commutator has a plurality of laminations, which have contact faces and are separated from one another by slots.

In operation, so-called brush noise can occur. The commutator is the primary excitation source for this. On the one hand, the brush is entrained via the friction of the contact face of the commutator and brush. The brush is excited to oscillate by what is known as the stick-slip effect. Moreover, among other factors, the imbalance that is due to dimensional inaccuracies (such as errors of concentricity, eccentricity, lamination discontinuities, etc.), excites the commutator to oscillate. The lamination slots of the commutator have particular significance in this respect. Each slot—because of the radial prestressing—causes the brush edge to slip the slot upon a rotation and excites it to travel. After that, the brush is forced out of the slot again, as a result of which it experiences both travel and force excitation. Especially the excitations at the exit are amplified here by the lamination discontinuity. The travel excitation is limited to the radial direction of the brush, while a force excitation occurs in the tangential direction. The number of laminations of the commutator has a primary influence on the frequency range affected. The corresponding slot frequency (f_{N}) depends on the number of laminations (i_{L}) and on the frequency of rotation of the commutator (ω_{K}). The result is the following formula: f_{N}=i_{L}*ω_{K}.

### ADVANTAGES OF THE INVENTION

The commutator of the invention for an electrical machine having the characteristics of claim 1 has the advantage over the prior art of making a favorable influence on the noise produced possible. To that end, the commutator has a plurality of laminations, which have contact faces and are separated from one another by slots; in at least some of the laminations, at least one groove is provided in the contact face and extends essentially in the longitudinal direction of the respective lamination. As a result, the incident slot frequency can be increased, so that by way of this the frequency range and hence the excitation of the brush are varied. The goal is to vary the slot frequency such that the resultant brush oscillations are outside the problematic range.

Such a commutator can be manufactured easily if the spacing of the slots and grooves is uniform.

The laminations remain mechanically quite stable if the depth of the grooves amounts to only a portion of the thickness of the laminations, preferably 0.5 mm.

Good noise behavior has been found to occur when there are two slots per lamination.

The noise can also be favorably affected if the diametrically opposed edges of adjacent laminations and the edges of the grooves are provided with a chamfer. Especially good results can be attained if the chamfers form an acute angle, preferably of 15° to 20°, with the contact face of the respective lamination. This angle serves as an inlet and outlet chamfer. As a result, the travel and force excitation that the brush experiences because of the slots is designed more harmoniously. Moreover, the edge wear at the brush is less.

The strongest effect in terms of noise can be attained with laminations distributed over the circumference of a drum commutator. From a production standpoint, it is favorable if the grooves are shorter than the slots.

If a commutator of this kind is used in an electrical machine that in turn is used in a drive unit, in particular for a motor vehicle, such as a power window system, sliding groove drive, drive train actuator, and in particular clutch actuator or the like, this results in improved noise performance in the electrical machine and the drive unit as well.

Further advantages and advantageous refinements will become apparent from the dependent claims and the description.

### DRAWING

One exemplary embodiment is shown in the drawing and described in further detail in the ensuing description. Shown are:

FIG. 1, a drive unit;

FIG. 2, a hook commutator in longitudinal section;

FIG. 3, an end view of the hook commutator of FIG. 2; and

FIG. 4, the detail IV of FIG. 3.

### DESCRIPTION OF THE EXEMPLARY EMBODIMENT

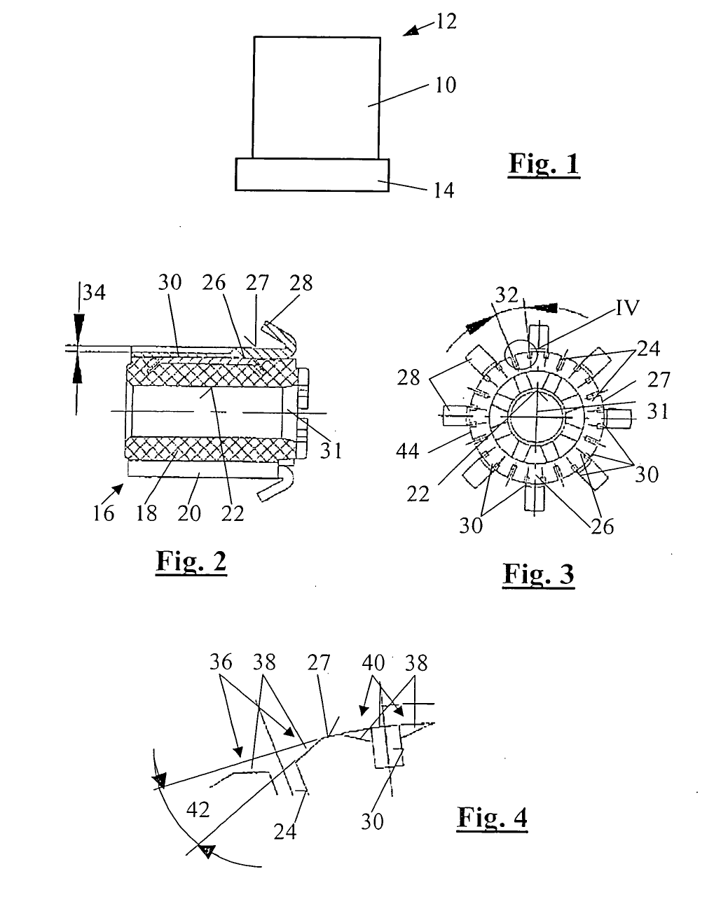

In FIG. 1, an electrical machine 10 is shown, which is part of a drive unit 12, which is preferably used in a motor vehicle. The drive unit 12 may be a power window system, a sliding groove drive, a drive train actuator, in particular a clutch actuator, or the like. A gear 14 is shown symbolically on the electrical machine 10.

In FIGS. 2 through 4, a commutator 16 is shown. The commutator 16 has a cylindrical commutator core 18 of a thermosetting plastic, which is surrounded by a metal conductor sleeve (20), particularly of copper. A receiving bore 22, in which the armature shaft, not shown, of the electrical machine 10 is located, extends in the commutator core 18.

Longitudinally extending slots 24 separate the conductor sleeve 20 into individual laminations 26, insulated electrically from one another, that have contact faces 27 for brushes, not shown, of the electrical machine 10. On one end, each of the laminations 26 has a connecting hook 28. A connecting wire, not shown, of the rotor winding is connected mechanically and electrically to each connecting hook 28. Since the laminations 26 are located on the circumference, the present exemplary embodiment is a drum commutator. The same number of laminations 26 as connecting hooks 28 are provided. In the present exemplary embodiment, this is eight each, but other numbers are also possible.

Two grooves 30 are provided on each of the laminations 26. It is also possible to provide only one groove, or more than one groove 30, per lamination. It is also possible to provide grooves 30 on only some of the laminations 26. The grooves 30 extend essentially in the longitudinal direction of the respective lamination 26. In the exemplary embodiment shown, the grooves 30 extend parallel to the center axis 31 of the commutator. However, an inclined course is also possible. The grooves 30 are shorter than the slots 24.

The spacing 32 of the slots 24 and of the grooves 30 is uniform. In the present exemplary embodiment, this spacing 32 is the angle from a slot 24 to the adjacent groove 30, or from a groove 30 to the adjacent groove 30, referred to the center axis 31 of the commutator 16. This spacing 32 or angle is calculated as 360°/iₛ, where iₛ is the total number of slots 24 and grooves 30. In the present exemplary embodiment, there are eight slots, which form eight laminations. Two grooves are provided on each lamination, resulting in 2*8=16 grooves. The result is iₛ=8+16=36. The spacing 32 is thus 10°.

It can also be provided that the slots 24 and grooves 30 are not uniformly spaced apart or distributed on the circumference. An asymmetrical arrangement may also have advantages in terms of noise.

The depth 34 of the grooves 30 amounts to only a portion of the thickness of the laminations 26, preferably 0.5 mm. However, other depths are also possible. It is also conceivable for the grooves 30, like the slots 24, to divide the laminations into portions.

As is shown more clearly in FIG. 4, the diametrically opposed edges 36 of adjacent laminations 26 are provided with chamfers 38, which extend longitudinally. The edges 40 of the grooves 30 are provided with a chamfer 38. The chamfers 38 form an acute angle, preferably of 15° to 20°, with the contact face 27 of the respective lamination 26. The chamfers 38 should be dimensioned such that a sufficiently large contact face 27 remains for the brushes.

The invention is naturally not limited to drum commutators. It can also be applied to radial commutators, also known as plane commutators, in which the laminations are located on an end face.

1-10. (canceled)

11. A commutator for an electrical machine, the commutator comprising a plurality of laminations each having contact faces and being separated from one another by slots, and
at least one groove formed in at least some of the laminations in the contact face, which at least one groove extends essentially in the longitudinal direction of the respective lamination.

12. The commutator as defined by claim 11, wherein the spacing of the slots and grooves is uniform.

13. The commutator as defined by claim 11, wherein the depth of the grooves amounts to only a portion of the thickness of the laminations, preferably about 0.5 mm.

14. The commutator as defined by claim 12, wherein the depth of the grooves amounts to only a portion of the thickness of the laminations, preferably about 0.5 mm.

15. The commutator as defined by claim 11, comprising two grooves on each lamination.

16. The commutator as defined by claim 12, comprising two grooves on each lamination.

17. The commutator as defined by claim 13, comprising two grooves on each lamination.

18. The commutator as defined by claim 11, further comprising a chamfer formed an opposed edges of adjacent laminations and the edges of the grooves.

19. The commutator as defined by claim 12, further comprising a chamfer formed an opposed edges of adjacent laminations and the edges of the grooves.

20. The commutator as defined by claim 13, further comprising a chamfer formed an opposed edges of adjacent laminations and the edges of the grooves.

21. The commutator as defined by claim 15, further comprising a chamfer formed an opposed edges of adjacent laminations and the edges of the grooves.

22. The commutator as defined by claim 18, wherein the chamfers form an acute angle, preferably of about 15° to 20°, with the contact face of the respective lamination.

23. The commutator as defined by claim 19, wherein the chamfers form an acute angle, preferably of about 15° to 20°, with the contact face of the respective lamination.

24. The commutator as defined by claim 20, wherein the chamfers form an acute angle, preferably of about 15° to 20°, with the contact face of the respective lamination.

25. The commutator as defined by claim 21, wherein the chamfers form an acute angle, preferably of about 15° to 20°, with the contact face of the respective lamination.

26. The commutator as defined by claim 11, wherein the laminations are disposed on the circumference of the commutator, embodied as a drum commutator.

27. The commutator as defined by claim 12, wherein the laminations are disposed on the circumference of the commutator, embodied as a drum commutator.

28. The commutator as defined by claim 11, wherein the grooves are shorter than the slots.

29. An electrical machine having a commutator as defined by claim 11.

30. A drive unit for a motor vehicle, such as a power window system, sliding groove drive, drive train actuator, and in particular clutch actuator or the like, having an electrical machine as defined by claim 29.
